(19) United States
(12) Patent Application Publication
(10) Pub. No.: US 2002/0026638 A1
(43) Pub. Date: Feb. 28, 2002

(54) Internet-based electronic program guide advertisement insertion method and apparatus

(76) Inventors: Charles A. Eldering, Doylestown, PA (US); Kyle Mehling, Buckingham, PA (US)

Correspondence Address: EXPANSE NETWORKS, INC., 300 NORTH BROADSTREET, DOYLESTOWN, PA, 18901, US

(21) Appl. No.: 09/742,506

(22) Filed: Dec. 21, 2000

Related U.S. Application Data
(60) Provisional application No. 60/229,156, filed on Aug. 31, 2000.

(51) Int. Cl. G06F 3/00; H04N 5/445; G06F 13/00

(52) U.S. Cl. 725/42

(57) ABSTRACT

The invention is a method and apparatus for delivering targeted Internet-based advertising for insertion into advertisement portions of an electronic program guide display for television.

This patent application claims priority of U.S. Provisional Application No. 60/229,156 filed on Aug. 31, 2000 entitled “Method and System For Addressable and Program Independent Advertising” which is incorporated herein by reference.

### FIELD OF THE INVENTION

The invention pertains to television advertising. More particularly, the invention pertains to advertising in the electronic program guide (EPG) of a television service delivery system.

### BACKGROUND OF THE INVENTION

Electronic Program Guides (EPGs) are well known in the television service delivery system field. As used herein, the term “television service delivery system” refers to any known or future method and/or apparatus for delivering television programming to viewers, including, but not limited to, digital broadcast satellite (DBS), analog cable, digital cable, switched digital video (SDV) delivered by a telephone service, and land-based radio frequency antenna broadcast.

The various modes of delivering television service, including those mentioned in the preceding sentence are herein termed transport mechanisms or transport streams. The term “television service provider” refers to entities that provide television service delivery systems. The term “subscriber” refers to any individual, household or other entity that receives television service delivery from a television service provider. In almost all possible television service delivery systems other than land based antenna broadcast, the subscriber actually enters into a service contract with the televison service provider in order to subscribe to the television service. In land-based antenna service, anyone with a television in the geographic area reached by the antenna can receive the television service without any contract with the broadcaster. Nevertheless, in this specification, the term subscriber is intended to include such entities.

An electronic program guide is a listing which can be displayed on the monitor (e.g., television) of a subscriber that displays a listing of the programs that are being offered on the various television channels of the system.

Most contract-based television service delivery systems, such as analog cable, digital cable, digital broadcast satellite (DBS), and switched digital video (SDV), include an EPG.

Normally, individuals receiving their television service via radio frequency broadcast using earth-based antennae do not have access to an EPG since there is no centralized television service provider, but rather, they simply receive whatever signals are being broadcast in their geographic by individual television stations (i.e., individual television channels). However, it certainly is possible for a broadcaster to broadcast an EPG showing the programming available through land-based antennae broadcast in a particular geographic area on one of the otherwise unused radio frequency broadcast channels received for television.

In analog cable television networks, the EPG is typically provided in one of the channels and comprises a scrolling screen showing the television program channels available through the cable network presently and for the next few hours on those channels.

In more recently developed television service delivery systems such as digital cable, SDV and DBS, the EPG also may be received in one communication channel of the televison service transport stream. In other systems, EPG data for a certain amount of time (e.g., one week) may be downloaded intermittently to a memory at the subscriber node and the interaction would be between the subscriber and the local memory.

Many EPGs are interactive such that a subscriber might be able to select a particular item in an EPG using his remote control unit in order to be provided additional information pertaining to that item. For instance, a user may position a cursor over an icon for a particular channel in order to obtain the programming information for that particular channel.

Normally, in the EPG, only a portion of the viewing area of the EPG is consumed with programming information. Typically, a portion of the screen is reserved for advertising. Particularly, one or more windows in the screen display advertisement which may comprise still picture advertising as well as moving picture advertising. Moving picture advertisements usually also include audio.

The advertisements displayed in the advertisement portion of the EPG display typically are included as part of the information transmitted in the channel (i.e., the EPG and ads comprise one signal).

PCT Publication WO 00/21287, which is incorporated herein by reference, relates to advertising in EPGs and discloses a method and apparatus for supplying video clips to viewers and displaying video advertising in EPGs.

Traditionally, a television service provider transmitted the same data to all of its subscribers.

However, modern digital television service methods, including SDV and digital cable, allow for the possibility of sending different data to different subscribers of the same provider. Theoretically, SDV allows different information to be send to any individual subscriber. While in SDV, this can be accomplished by transmitting data to individual subscribers, the same can be accomplished in digital cable, either by sending different data to each subscriber over a data channel such as that which can be provided using a cable modem, or by broadcasting the data over a carousel and having each digital set-top pick off the appropriate information. The term addressable units is used herein to designate the nodes of the communication system that are individually addressable (e.g., each subscriber's STB in SDV or a local node in digital cable) such that different data can be sent to them.

This ability to more individually target subscribers is of great interest to advertisers, since it presents an opportunity to send different advertising to different subscribers or groups or subscribers. Thus, correlating addressable groups of subscribers with demographic data or the like can allow advertisers the opportunity to transmit advertisements to a more select group of television viewers corresponding to their target audience. For instance, a cable television provider can sell advertising spots in the television programming delivered to its more affluent subscribers to different advertisers than its less affluent subscribers. Thus, the cable television network operation, in essence, could sell the same advertisement spot to two or more advertisers with each advertiser still reaching most, if not all, of its intended audience.

Many of the digital television service methods (digital cable, DBS, SDV) as well as analog cable television services require the use of a set top box (STB) coupled between the subscribers' television monitor or monitors and the transport mechanism (e.g., the cable in the case of analog or digital cable, the telephone line in the case of SDV, or the satellite receiving antenna in the case of DBS). In many SDV, DBS and digital cable systems, two-way communication between a subscribers' set top box and the service provider (hereinafter the head end) is possible. The upstream information flow (from the set top box to the head end) may be through the same transport mechanism as the downstream flow or may be a completely different mechanism. For instance, in DBS, the downstream information is received via satellite antenna reception. However, typically, the upstream information is sent to the head end through the telephone lines. Further, depending on the particular system, the service provider can send different data to different subscribers either by group or individually. One of the advantages of the ability to more specifically address subscribers is the ability to deliver more narrowly targeted advertising to individuals or groups of individuals.

Accordingly, it is an object of the present invention to provide an improved electronic program guide.

It is another object of a present invention to provide a method and apparatus for delivering targeted advertising to television subscribers.

It is a further object of the present invention to provide a method and apparatus for delivering targeted advertising to an EPG of a television subscriber that is simple, quick, reliable and can be readily updated.

### SUMMARY OF THE INVENTION

In accordance with the invention, advertisements (ads) for display in an EPG are in an Internet based format such as HTML and are downloaded at the addressable units from a network, such as the Internet. In at least one preferred embodiment, the ads are downloaded and stored locally at a memory associated with the addressable units. Alternately, they may be downloaded in real time from a remote node of the televison service delivery network at the time of display.

In either case, an EPG ad queue can be maintained in RAM at the addressable unit, the queue containing an ordered list of advertisement identifiers. The advertisement identifiers may comprise URLs on the World Wide Web.

The EPG itself also may be Internet based and delivered to the addressable units in the same manner as the ads, e.g., through the Internet.

Delivery of the advertisements and/or EPG may be through a separate transport stream than the television programming transport stream. For instance, in digital cable and SDV, one of the channels in the transport stream may be dedicated to Internet access or even just advertising via Internet access. In analog cable, the Internet based advertisements and/or EPG may be retrieved through a DOCSIS (data over cable) channel carried on the cable using a DOCSIS modem in the subscriber set-top box. In DBS systems, the advertisement may be provided through a channel transmitted from the satellite itself or through a completely separate transport stream, for example, the telephone lines.

The addressable units can be preprogrammed to download and organize the advertisement identifiers in the queue in accordance with a predetermined scheduling algorithm. Alternately, they may be programmed to receive scheduling instructions intermittently from a head end. The scheduling algorithms can include the order in which the ads will be displayed, the position of the ads in the EPG (if the EPG supports multiple, simultaneous ad windows), and the duration that the ads will be shown.

Preferably, the scheduling algorithm determines when the EPG is being displayed and displays advertisements only when the EPG is being viewed.

The advertisements may comprise streaming video and/or streaming audio files embedded within Internet based files.

### BRIEF DESCRIPTION OF THE DRAWINGS

FIG. 1 is a diagram of an EPG.

FIG. 2 is a block diagram of an exemplary set top box in accordance with the present invention.

FIG. 3 is a flow diagram illustrating the steps involved in downloading EPG advertisement queue in accordance with an embodiment of the present invention.

FIG. 4 is a flow diagram illustrating the steps involved in inserting advertisements into the EPG in accordance with an embodiment of the present invention.

### DETAILED DESCRIPTION OF THE INVENTION

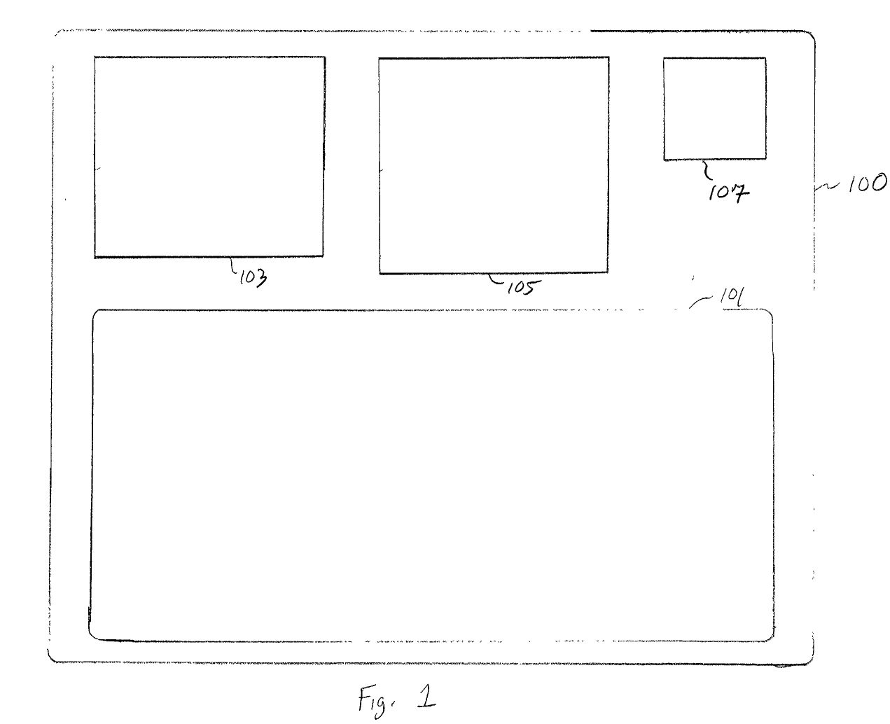

FIG. 1 is a screen shot of a typical EPG 100. It comprises an area (or window) 101 for displaying program information for the multiplicity of channels of television service provided by the television service provider. It further includes one or more windows 103, 105, 107 for displaying advertisements in the EPG. The advertisements may be static (in the nature of a billboard) or moving picture (with or without accompanying audio).

The television service delivery system may comprise any type of communication system, such as a digital cable network, an analog cable network, a DBS communication system, and an SDV network using the phone lines and VDSL modems.

In the prior art, typically, the entire EPG 100, including advertisements, is created at the head-end by the television service provider and transmitted to the subscribers via the communication systems in one of the channels of the system.

However, in accordance with the present invention, the EPG advertisements comprise Internet based data files (e.g., web pages) transmitted to the addressable units separately from the television programming.

The term “internet based” as used herein is intended to encompass all of the computer languages, file formats, and protocols commonly used in connection with Web pages on the World Wide Web and accessed through the Internet. This includes, but is not limited to, HTML, SGML, XML, XHTML, Dynamic HTML, Style Sheets (e.g., CSS1 and CSS2), and Javascript languages. It also is intended to encompass multimedia and other types of files that can be embedded within or associated with Web pages, such as, but not limited to MPEG, AVI, RAM, RM, QuickTime, Real Audio, Real Video, Windows Media, Java (e.g., Java applets), Javascript, ActiveX, SMIL 1 (Synchronized Multimedia Integration Language) Flash, MP3, WAV, AU, MIDI, MID, EPS, VRML, JPEG, GIF, and AAC files.

The ads for display in an EPG can be coded in any industry standard, Internet-readable format that would allow for viewing of the ads via software from a hardware-independent addressable unit. Similar to a web-browser, the addressable unit will be able to process and display a wide range of file types that would include but are not limited to: HTML and its various implementations of displaying text and graphics, as well as multimedia files, both standalone or embedded in HTML such as Java, Flash, RealMedia, compressed video in its various implementations (e.g., MPEG, AVI, RAM, RM, QuickTime) and compressed audio in its various implementations (e.g. MP3, WAV, AU, AAC).

The transport mechanism for the Internet-based advertisements may be the same as for the television programming (i.e., a separate channel in the same transport stream). For example, in an analog cable television service delivery network, the ads can be transmitted to the set-top box over a DOCSIS channel transported over the cable. Alternately, the ads may be delivered via an entirely separate transport mechanism. For example, in DBS, the ads may be received via an Internet connection through the telephone lines.

The advertisement files may comprise HTML pages that include streaming video and/or streaming audio files embedded therein. The guide portion 101 of the EPG also may be an Internet based file.

The ads may be transmitted to the addressable units in advance and stored locally at the addressable units for later retrieval for insertion into the EPG. Alternately, the ads may be retrieved in real time at or just prior to the time of display. The addressable units include circuitry for inserting the ads into the EPG in real time. In certain embodiments, the advertisements and the guide portion of the EPG may be combined to form a single HTML file. In other embodiments, the guide portion and the advertisements may each comprise different frames in a frameset in a manner that would be understood by persons of skill in the art of Web page design and implementation.

The addressable units would be programmed or otherwise designed to receive and/or store the appropriate ads, retrieve the ads at the appropriate time, and insert the ads into the EPG. The addressable units also should generate and maintain a schedule for inserting the ads into the EPG. This scheduling algorithm may be pre-programmed into the addressable unit or may be changeable via instructions received from the head end periodically.

Some advantages of real time ad delivery are that there is no need for extra memory at each subscriber's node for storing the ads, which may comprise very large files, especially if they include streaming media files. Further, any changes that the advertiser wishes to make to the ads, including substituting an entirely new ad for an older one, can be made on the advertiser's server without the need to re-load the subscriber's memory.

The ads can be retrieved from the memory for display and/or retrieved in real time for display according to any reasonable scheduling algorithm. For instance, ads may be rotated for display with a changeover occurring at predesignated intervals. Alternately, certain ads may be displayed at certain times of day. In accordance with another embodiment, if the individual addressable units are the STBs of the individual subscribers, ads may be rotated after a certain period of time that they have been displayed on the monitor. In such embodiments, the scheduling algorithm would include some means of determining whether the ads are displayed on the monitor.

In a simple embodiment, one may assume that, if the set top box is tuned to the EPG channel, it is being viewed. Accordingly, in such an embodiment, the ads can be rotated after a certain period of time that the EPG channel has been tuned in. However, those of skill in the art will understand that the fact that a set top box is tuned to the EPG channel does not mean that someone is viewing it. Particularly, persons often forget to turn off their set top boxes after they turn off their television monitors. Even further, sometimes subscribers leave the television on while they are not in the room. Thus, in more complex embodiments, EPG tuning detection may be combined with other means of determining whether the television monitor is on or even whether someone is viewing it. There are a number of methods which can be used to determine, probabilistically, whether an individual is viewing a turned-on television set. For instance, an algorithm can be developed in which it is assumed that no one is viewing the EPG even if the television is on and the EPG channel is tuned in if a certain amount of time has elapsed since a remote control command has been received by the set top box.

Furthermore, there are several means by which it may be determined whether the TV monitor is on. For instance, if the television is plugged into a power outlet of the set top box, the set top box can simply detect whether sufficient current is running to the television to indicate that it is on. Alternately, a horizontal oscillator detector can be incorporated into the set top box and used to provide a probabilistic determination of whether there is a TV on in the vicinity of the STB by detecting horizontal oscillation output of a typical television. Another potential method is to provide a detector for detecting the high voltage chroma subcarrier common to an operating television. U.S. patent application Ser. No. ______ (Attorney Docket No. P-24,475) entitled “Method and System for Addressing Targeted Adertisements Using Detection of Operational Status of Display Device”, invented by John Blasko et al., filed on or about Dec. 7, 2000, and assigned to the same assignee as the present application discusses various methods and apparatus for detecting when a television is on for targeted advertising purposes and is incorporated herein by reference.

In at least one embodiment, the identity and order of the ads which are to be displayed in the advertising portions of the EPG screen are stored in a queue in RAM at the addressable unit. At a simple level, the individual entries in the queue may simply comprise the location of the file comprising the advertisement (hereinafter termed advertisement resource locator or ARL), and the ads can be retrieved in accordance with an order of the ARLs in the queue. In the case of local storage, the ARL would be a memory address in the local memory. The ARL may be a URL (Uniform Resource Locator) of the ad on the World Wide Web.

Once an ad file is retrieved, it can be inserted into a portion of the EPG display screen in any reasonable manner. Several methods and apparatus for splicing visual information into a video/audio stream are known in the prior art. For instance, if the EPG itself is HTML based, the advertisements could simply be inserted as subwindows in the viewing area in any of several well-known manners, such as by using frames in a frameset, which would be readily familiar to those skilled in Web page design and programming. Alternately, technology is presently available for inserting advertisements within another video display. For instance, the same technology which is now often used in television broadcasts of sporting events in which virtual billboards are inserted in the background or a virtual first down line is inserted on a football field can also be applied to insert the advertisements into the EPG in accordance with the present invention. Such technology is available, for instance, from companies such as Princeton Video Insertion.

Using Internet-based advertising as disclosed herein provides many advantages not possible in standard television advertising methods. First, a transport mechanism for delivering the advertising to households is readily available, namely, the Internet and telephone system. Second, targeted advertising can be delivered to subscribers without the need for any addressability in the transport mechanism for the actual television programming (or EPG). All that is necessary is a connection to the Internet (or any other network) and an STB (or other addressable unit) with the capability of inserting display elements into another display.

In accordance with the invention, the television service provider sells places in the electronic program guide of the viewers corresponding to the addressable units to advertisers based on available information about the corresponding subscribers. Such information may include publicly available demographic and psychographic information, as well as more individualized information which may be obtained through questionnaires filled out by subscribers.

In accordance with the invention, a virtual roadblock can be set up whereby the subscriber will receive the designated ads in the designated order regardless of when the subscriber views the electronic program guide. In this manner, advertisers can more specifically reach their target audience while also being given a much higher level of confidence that their ads have actually been viewed by the target audience.

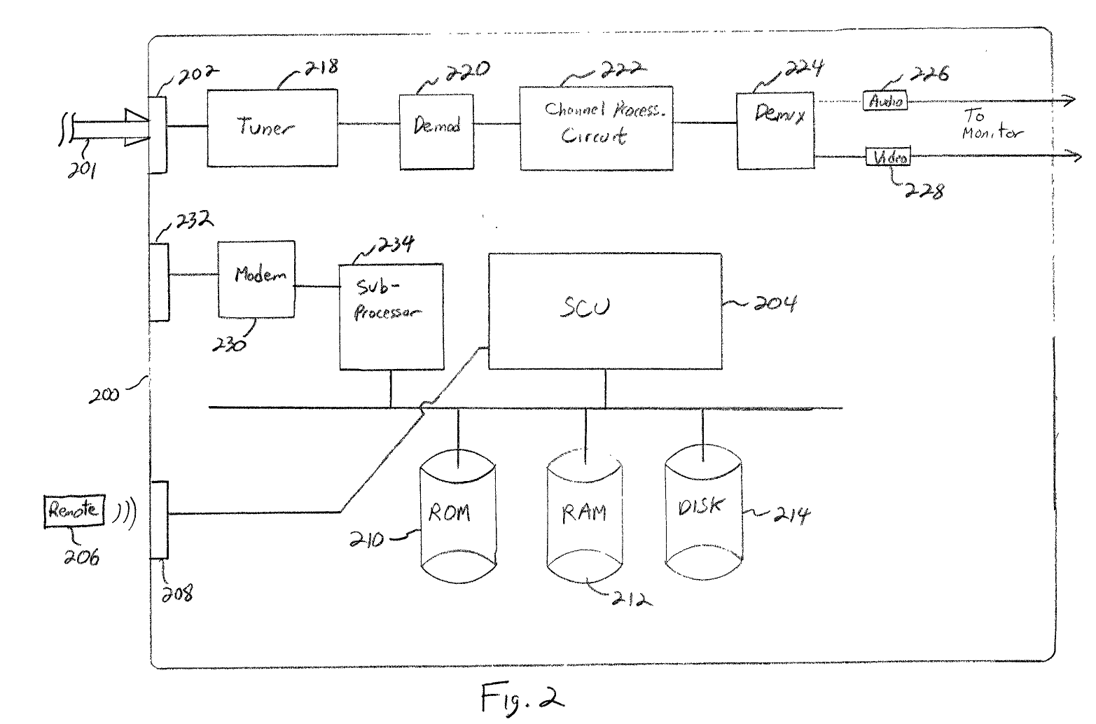

FIG. 2 is a block diagram illustrating a set-top box in accordance with the present invention and assuming that the pertinent television delivery service system supports individual addressing of STBs. FIG. 2 does not necessarily show all of the components of a set-top box but primarily only those that are relevant to the present invention. For exemplary purposes, the set top box 200 of FIG. 2 is a set top box for a digital cable network television service delivery system. Most of the components would exist in a set top box for most other television service delivery systems in any event. Further, we will assume for exemplary purposes that the EPG is transmitted to the STB in one of the channels of the digital cable transport stream.

Set-top box 200 includes an input port 202 for coupling to the input signal.

The input signal comprises a stream of television programming comprising multiple channels. The set-top box includes a system control unit 204 that controls operation of the components of the STB. The system control unit 204 essentially is a central processing unit (CPU) and may comprise any digital processing device, such as a microprocessor, finite state machine (FSM), digital signal processor (DSP), application specific integrated circuit (ASIC), a programmed general purpose computer, etc.

The system control unit 204 receives commands from the subscriber, such as through infrared (IR) reception of commands from a hand held remote control unit 206 through an IR receiving circuit 208, decodes the commands, and forward control signals to other circuits in the set-top box 200 in order to carry out the subscriber's command. Such commands might include channel selection, volume control, and on/off. The STB further includes a read only memory (ROM) 210 containing fixed software instructions and fixed data for operating the STB, and a random access memory (RAM) 212 for storing changeable data, such as the queue, instructions for organizing the queue, and advertisements in accordance with the present invention. Preferably, STB 200 also includes a separate large volume memory device 214, such as a hard disc drive or optical disc drive which can be used instead of the RAM for storing files which are very large in size, such as television programs or streaming audio/video advertisements.

The SCU 204, ROM, 210, RAM 212, and large volume memory 214 are coupled to a master bus 216 over which the units can communicate with each other.

The input signal from input port 202 is passed through a tuning circuit 218. Under control of the system control unit 204, the tuning circuit selectively parses out the data corresponding to the particular channel selected by the viewer. The tuned channel is passed to a demodulator 220 that demodulates the data.

A channel processing circuit 222 takes the demodulated channel data and processes it as needed. The necessary channel processing depends on the particular form of the input data and the features of the STB. In some instances, very little, if any, processing is necessary. In others, significant processing may be necessary. In the case of an EPG channel in accordance with the present invention, at least one of the functions performed by the channel processing circuit 222 is the insertion of the ads into the EPG. Other exemplary functions that might be performed in the channel processing circuit 222 include decoding and encoded data streams (e.g., MPEG, Dolby SurroundSound™). The channel processing circuit may take any reasonable form. It should be understood that the term circuit is used in this specification inclusively to encompass analog circuits and digital circuits, including finite state machines, digital signal processors, computers, central processing units, ASICs, and programmed general purpose processors. Most likely, the channel processing circuit is a digital processor and, in fact, may comprise the same processor that comprises the SCU 204.

If any of the data received from the input port 202 is to be stored locally at the STB, the channel processing circuit 222 can pass that data to one of the memory devices 212 or 214 for storage through the system control unit 204.

The output of the channel processing circuit 222 typically is coupled to a de-multiplexer 224 which separates the audio and video portions of the channel and forwards them to audio and video output ports 226 and 228, respectively. These ports normally would be coupled to the audio and video input ports, respectively, of the subscriber's television.

In the particular embodiment illustrated in FIG. 2, the advertisements for insertion in the advertisement areas of the EPG are received via a different transport stream from the television programming channels and, particularly, via the Internet through the telephone lines 229 and a modem 230. It should be understood by persons of skill in the art that this is merely an example and that the advertisements, ARLs and queue organization instructions may be received by other means, such as in a dedicated channel in the main transport mechanism 201.

The STB further includes a subprocessor 234, coupled between the modem and the SCU 204. In this particular embodiment, the advertisements, ARLs and instructions for organizing the queue are received via the Internet via modem 230. The sub-processor 234 is dedicated to processing Internet based files, running file transfer protocol (FTP) for receiving streaming audio, streaming video and other files, receiving instructions from the head end for schedule generation in accordance with the instructions received from the head end. In this embodiment, we will assume that the advertisements are downloaded ahead of time and stored locally in memory 214 for retrieval at the time of insertion. Accordingly, modem 230 receives Internet based files. They are processed in the subprocessor 234 and stored in the large volume memory 214. Modem 230 also receives ARLs and instructions for generating a schedule for EPG ad insertion. As previously noted, the ARLs may comprise URLs on the World Wide Web.

The exact manner in which ads, ARLs and/or instructions are received can take many forms. For instance, the modem may connect directly via the telephone lines to a server maintained by the television service provider to retrieve such information. Alternately, the modem may be connected to an Internet service provider (ISP) and the modem can connect to the television service provider's Internet server via the Internet. If the modem is coupled to a dedicated line, the server may simply send instructions, ads and ARLs addressed to the particular STB at predesignated intervals. If the modem is connected to a non-dedicated line, the STB may be programmed to call in to the server (whether through the Internet or directly) at predetermined intervals to request a download of such information. Aforementioned U.S. Provisional Patent Application No. 60/229,156 and U.S. patent application Ser. No. ______, filed on or about Nov. 14, 2000, entitled “Queue Based Advertisement Scheduling and Sales”, invented by Charles Eldering and Gregory Flickinger, disclose even further possible methods and apparatus for delivering ads, ARLs and instructions to the STBs.

In order to display the ads in the EPG, the subprocessor 234 and/or the main SCU 204 consults the schedule in order to determine what ads are to be displayed when and where in the EPG. The ads are then retrieved, e.g, via the Internet in real time or from the local memory, and are forwarded to the channel processing circuit 222. The channel processing circuit then inserts the ads into the EPG.

In accordance with the present invention, it may be desirable for the STB to send information to the head end indicating when an advertisement has been displayed in the EPG so that the television service provider can bill the advertiser for having shown the ad. In such a case, the modem 230 could be used for transmitting as well as receiving through port 232. In this particular embodiment, the system control unit 204 can transmit information upstream through subprocessor 234, modem 230 and port 232.

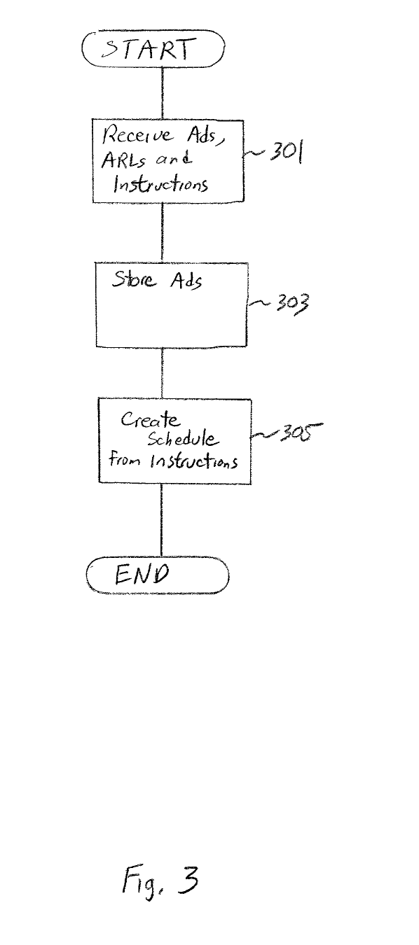

FIG. 3 is a flowchart illustrating one exemplary process flow for receiving EPG advertisements, ARLs, and the information/instructions for organizing the queue. In step 301, ARLs, instructions for organizing the ARLs and the queue and advertisements are received via the modem. In step 303, the ads are stored to the large memory 214. In step 305, the instructions for organizing the queue are processed to create a queue comprising a list of ARLs and designating an order in which the ads corresponding to the ARLs are to be displayed.

This process may be repeated at particular intervals, e.g. every week. In one embodiment, the EPG advertisement queue may be completely rewritten at these intervals. In other embodiments, new ARLs may simply be added to the queue while any ARLs corresponding to advertisements which have not yet been displayed remain in the queue.

FIG. 4 is a flowchart illustrating ad insertion in accordance with one particular embodiment of the invention. In this embodiment, the ads are retrieved and displayed only when it is determined that the set top box has tuned in to the EPG channel. Accordingly, the processing illustrated in the flow chart of FIG. 4 is commenced at step 402 upon indication that the EPG has been tuned in. This may be indicated by an interrupt signal or a flag being set in a manner well known in the art. In step 404, the EPG is displayed. In step 406, subprocessor 234 consults the schedule to determine what ad or ads should be displayed in what windows in the EPG and for how long. In step 410, the ads are retrieved, such as from the local memory or from a remote server as the case may be. In step 410, the ads are inserted into the EPG.

In this example, we will assume that the television service provider has arranged with the advertisers to display the ads for a particular period of time that the EPG channel is tuned in. Accordingly, in step 414, a timer is started corresponding to each ad that is being displayed. In step 414, it is determined whether the total display period for each ad has been reached. If so, flow proceeds to step 414 in which the queue is updated. In a simple embodiment, this simply may involve deleting the ARL for the ad that was just displayed. Flow then proceeds to step 420, in which the fact that the ad was displayed is reported back to the television service provider. This may involve immediately sending the information upstream to the head end via the modem. In other embodiments, it may involve writing this data to a storage location in local memory, for sending upstream, along with the contents of other related storage locations, at a later time. In step 421, the counter for that ad is reset. Flow then returns to step 406 where the queue is consulted again to determine what advertisement should be inserted in place of the one just removed.

If, on the other hand, in steps 416, no ads have timed out, flow proceeds to step 422 where it is determined if the EPG is still tuned in. If yes, flow proceeds back up to step 416 and loops through steps 416 and 422 (with a possible detour to steps 418-420 et seq.) until the EPG is tuned out. At that point, flow proceeds from step 422 to step 424 where the timers are stopped and stored in memory for retrieval when the EPG is next tuned in.

The invention allows advertising to be delivered independently from the EPG and in formats, e.g., HTML, streaming video, different from the EPG. This allows for the possibility of more individually targeting advertisements than may be available through direct incorporation into the EPG stream.

For instance, the invention can be used with an analog cable system having no addressability in connection with the television program and EPG transport stream. The ads can be downloaded through an entirely different transport mechanism that allows for individual STB addressability.

Further, in situations where the ads are not stored locally, but are retrieved via the Internet or through a direct connection over the telephone lines or any other network, the ads can be updated by the advertiser on their own server and thereafter be immediately available for display to the subscriber(s) the next time the subscriber tunes in the EPG. Further, in such embodiments, the subscriber need not have memory suitable for storing ads.

In addition to simple HTML files, the ads may also include streaming audio and/or streaming video, which, depending upon the bandwidth of the subscriber's connection can also be delivered in real time. Alternately, if sufficient bandwidth is not available for real-time delivery, they may be delivered ahead of time and temporarily stored at the subscriber's node.

Many scheduling algorithms are possible, including time based scheduling in which an ad is changed at fixed intervals regardless of whether the EPG has been tuned in or not. Another option is a single view option in which a new ad is retrieved and displayed each time the EPG is tuned in, at which time that ad is discarded. In another embodiment, an ad might be shown a certain number of times the EPG has been tuned in, either consecutively or interleaved with other ads, with the ads being counted as displayed each time the EPG is newly tuned in. Another option is to display an ad at a certain time of day. Any combination of any of the above methods also can be utilized.

Streaming audio can be in any streaming audio format such as Real Audio or Microsoft Windows Multimedia format. Streaming video may be in any of a number of formats, such as MPEG.

Since streaming audio and/or video may not be able to be downloaded quickly enough to be displayed immediately, particularly if the STB has a low bandwidth connection, a less bandwidth intensive Internet based ad can be displayed initially while the streaming audio or video file is downloaded. As soon as the file is sufficiently downloaded and ready for playback, the still ad can be replaced with the streaming video/audio ad.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed:

1. A method of providing advertising in an electronic program guide for television, said method comprising the steps of:
delivering an electronic program guide to an addressable unit using a first communication channel;
delivering at least one advertisement to said addressable unit in a second communication channel, said at least one advertisement being comprised of an Internet accessible file; and
inserting said advertisement into said electronic program guide.

2. The method of claim 1 wherein said first and second channels are different channels of a single transport stream.

3. The method of claim 1 wherein said first channel and said second channel comprise first and second transport streams, respectively.

4. The method of claim 3 wherein said first transport stream is one of analog cable, digital cable, digital broadcast satellite and switched digital video.

5. The method of claim 4 wherein said second transport system comprises the Internet.

6. The method of claim 1 wherein said Internet file comprises an HTML file including one or more of a streaming video file, a streaming audio file, a Java file, a FLASH file, and a Javascript file associated therewith.

7. The method of claim 1 wherein said advertisement delivery step comprises the steps of:
storing said at least one advertisement on a network comprising said second channel at a node remote from said addressable unit; and
retrieving, at said addressable unit, said at least one advertisement from said remote node responsive to determination of an advertisement insertion opportunity.

8. The method of claim 1 wherein said advertisement delivery step comprises the steps of:
delivering said at least one advertisement to said addressable unit at a time prior to determination of an opportunity to insert said advertisement into said electronic program guide; and
storing said advertisement in a memory local to said addressable unit for later retrieval responsive to determination of an advertisement insertion opportunity.

9. The method of claim 8 wherein said insertion step further comprises retrieving said at least one advertisement from said local memory.

10. The method of claim 1 wherein said advertisement inserting step comprises the steps of:
determining if the electronic program guide is being viewed;
if said electronic program guide is being viewed, inserting said at least on advertisement into said electronic program guide.

11. The method of claim 1 wherein said at least one advertisement comprises a plurality of advertisements, said method further comprising the steps of:
creating a schedule for displaying said advertisements in said electronic program guide; and
wherein said inserting step comprises inserting said advertisements in accordance with said schedule.

12. The method of claim 11 wherein said step of creating a schedule comprises storing a queue in a memory, said queue comprising an ordered list of advertisement resource locators (ARLs), each of said ARLs comprising data disclosing a location of a corresponding advertisement.

13. The method of claim 12 wherein said queue is stored locally at said subscriber node.

14. The method of claim 13 further comprising the step of:
delivering to said subscriber node instructions dictating how to schedule said advertisements for display in said electronic program guide; and
wherein said step of creating said schedule comprises executing said instructions.

15. The method of claim 14 wherein said ARLs comprise URLs on the World Wide Web.

16. The method of claim 1 wherein said electronic program guide includes a plurality of spaces dedicated to insertion of advertisements and wherein said inserting step comprises inserting an advertisement in each of said spaces.

17. The method of claim 11 wherein said schedule defines an expiration event for each advertisement and wherein said method further comprises the steps of:
detecting said expiration event for any advertisement that is being displayed in said electronic program guide;
removing a presently displayed advertisements upon detection of said expiration event corresponding to said advertisement;
upon removal of any advertisement from said electronic program guide, consulting said schedule to determine a next advertisement to be inserted in said electronic program guide; and
inserting said next advertisement in said electronic program guide in place of said removed advertisement.

18. The method of claim 1 wherein said electronic program guide comprises an HTML file.

19. An apparatus for providing advertising in an electronic program guide for television comprising:
a receiver for receiving an electronic program guide for television via a first communication channel;
a receiver for receiving advertisements via a second communication channel, said advertisements comprising Internet based files; and
an advertisement insertion circuit for inserting said advertisements into said electronic program guide.

20. The apparatus of claim 19 further comprising a processing circuit for processing said HTML files to generate displays corresponding thereto that can be inserted into said electronic program guide.

21. The apparatus of claim 20 wherein said first and second channels are different channels of the same transport mechanism.

22. The apparatus of claim 21 wherein said first and second channels comprise different transport mechanisms.

23. The apparatus of claim 22 wherein said first transport mechanism is one of analog cable, digital cable, digital broadcast satellite and switched digital video.

24. The apparatus of claim 23 wherein said second transport mechanism comprises one or more of a DOCSIS modem, a telephone network and the Internet.

25. The apparatus of claim 19 wherein said Internet based file comprises an HTML file including one or both of a streaming video file, a streaming audio file, a Java file, a FLASH file, and a Javascript file associated therewith.

26. The apparatus of claim 19 further comprising:
means for retrieving said advertisements from a remote location coupled to said apparatus via said second transport mechanism responsive to determination of an advertisement insertion opportunity in said electronic program guide.

27. The apparatus of claim 19 further comprising:
means for retrieving said advertisements at a time prior to determination of an opportunity to insert said advertisement into said electronic program guide; and
a memory for storing said advertisements for later retrieval responsive to determination of an advertisement insertion opportunity in said electronic program guide.

28. The apparatus of claim 27 wherein said advertisement insertion circuit comprises means for retrieving said advertisements from said memory.

29. The apparatus of claim 19 further comprising:
a circuit for determining if said electronic program guide is being viewed; and
wherein said advertisement insertion circuit inserts said advertisements into said electronic program guide only if said circuit for determining determines that said electronic program guide is being viewed.

30. The apparatus of claim 19 further comprising:
a circuit for creating a schedule for displaying said advertisements in said electronic program guide; and
wherein said advertisement insertion circuit inserts said advertisements into said electronic program guide in accordance with said schedule.

31. The apparatus of claim 30 wherein said circuit for creating a schedule creates a queue in a memory, said queue comprising an ordered list of advertisement resource locators (ARLs), each of said ARLs comprising data disclosing a location of a corresponding advertisement.

32. The apparatus of claim 31 further comprising:
a receiver for receiving instructions dictating how to order said ARLs in said queue; and
wherein said circuit for creating said schedule does so in accordance with said instructions.

33. The apparatus of claim 32 wherein said ARLs comprise URLs on the World Wide Web.

34. The apparatus of claim 19 wherein said schedule defines an expiration event for each advertisement and wherein said advertisement insertion circuit further comprises:
means for detecting said expiration event for any advertisement that has been displayed in said electronic program guide;
means for removing said displayed advertisement upon detection of said corresponding expiration event; and
means for consulting said schedule upon removal of any advertisement from said electronic program guide to determine a next advertisement to be inserted in said electronic program guide and inserting said next advertisement in said electronic program guide in place of said removed advertisement.
